(19) United States
(12) Patent Application Publication
(10) Pub. No.: US 2008/0222274 A1
(43) Pub. Date: Sep. 11, 2008

(54) Method and system for an interactive, web-based environment

(76) Inventor: Joshua Millstein, Lawrence, KS (US)

Correspondence Address: STEPHEN R. ROBINSON, 1121 PENNSYLVANIA, LAWRENCE, KS, 66044, US

(21) Appl. No.: 11/716,093

(22) Filed: Mar. 9, 2007

(51) Int. Cl. G06F 15/16

(52) U.S. Cl. 709/219

(57) ABSTRACT

A method providing an online environment for a user to interact with a decision tree. The method includes operating a webserver providing a web-based, interactive decision tree, including communication content. The content is distributed by first transmitting a user interface, including the interactive decision tree, to a web browser operated by a user. The decision tree includes user interactive choices. The web server then receives a message from the user indicative of his selection of one or more choices. The web server then modifies the user interface to incorporate the user's selected choices. The server then transmits the modified user interface incorporating the choices to the web browser operated by the user so that he receives an appropriate response to the choices.

One of the user's choices is uploading video content. Also preferred is a technique whereby the user may playback a sequence of content chapters with one selective action.

### BACKGROUND OF THE INVENTION

1. Field of the Invention

The present invention relates to a method and system utilizing a web-based, interactive environment. More particularly, it is directed to an online environment using a decision tree made up of informational content chapters.

2. Description of Related Art

The Internet revolution has brought together many people who would not otherwise have met. Virtual communities have sprung up, allowing people separated geographically to discuss issues, trade information and display digital photographs and other images to each other. One common activity is to post opinions on a virtual bulletin board. As other members view the opinion, they have the option to respond, thereby creating a discussion thread which may eventually include many members of the community.

A more recent development is the use of full streaming video (“video content”) on websites. Youtube.com has become a phenomenal success due to the ability of individuals to post whatever video content is desired to share in a public environment. However, as of yet, no one has offered a satisfactory environment where video content may be used in threads (also referred to as “branches”), whether it be for community discussion, collaborative creation of a fictional story or the use of segmented video content to provide a training scenario.

What is needed is a web-based environment which facilitates discussion, collaboration or training through the use of video content and other information. In particular, the environment should allow the informational content to be organized in “trees” made up of “branches,” so that the user can have a full range of interactive choices.

### SUMMARY OF THE INVENTION

The present invention solves the problems of the prior art by providing a convenient web-based environment for a user to interact with a decision tree offering content choices. In preferred embodiments the method includes operating a computer system having a web server. An online environment is provided featuring a web-based, interactive decision tree, including communication content. The content is distributed to one or more users by first transmitting a user interface, including the interactive decision tree, to a web browser operated by an individual user. The interactive decision tree includes predetermined user interactive choices. The web server then receives a message from the user indicative of the user's selection of one or more of the predetermined interactive choices. The web server then modifies the user interface to incorporate the user's selected interactive choices. The server then transmits the modified user interface incorporating the selected choices to the web browser operated by the user so that the user receives an appropriate response to the interactive choices.

In particularly preferred embodiments, one of the user's choices is uploading content to the web server, especially video content. Also particularly preferred is a technique whereby the user may playback a sequence of content chapters with one selective action.

### BRIEF DESCRIPTION OF THE DRAWINGS

FIG. 1 partially illustrates a web-based, online environment according to the invention, in particular the homepage thereof;

FIG. 2 is a box diagram indicating the system within which the environment operates;

FIG. 3 illustrates in schematic fashion elements of a computer used in conjunction with the environment;

FIG. 4 is a screenshot illustrating the environment in operation;

FIG. 5 is another screenshot of the environment in operation;

FIG. 6 is a flow diagram indicating a process used in furtherance of the environment;

FIG. 7 is another flow diagram used in furtherance of the environment;

FIG. 8 is another flow diagram indicating a process used in furtherance of the environment;

FIG. 9 is another flow diagram indicating a process used in furtherance of the environment;

FIG. 10 is a flowchart illustrating major processes conducted in the environment;

FIG. 11a is a box diagram representing a set of root node content chapters;

FIG. 11b is a box diagram representing a set of root node content chapters with one original content chapter uploaded sequentially to one particular root node content chapter;

FIG. 11c is a box diagram representing a set of root node content chapters with a second level of four content chapters all sequentially connected to one particular root node content chapter; and;

FIG. 11d is a box diagram representing a set of root node content chapters with a second level of four content chapters all sequentially connected to one particular root node content chapter, and a second root node content chapter which is sequentially linked to one content chapter from the second level.

### DETAILED DESCRIPTION

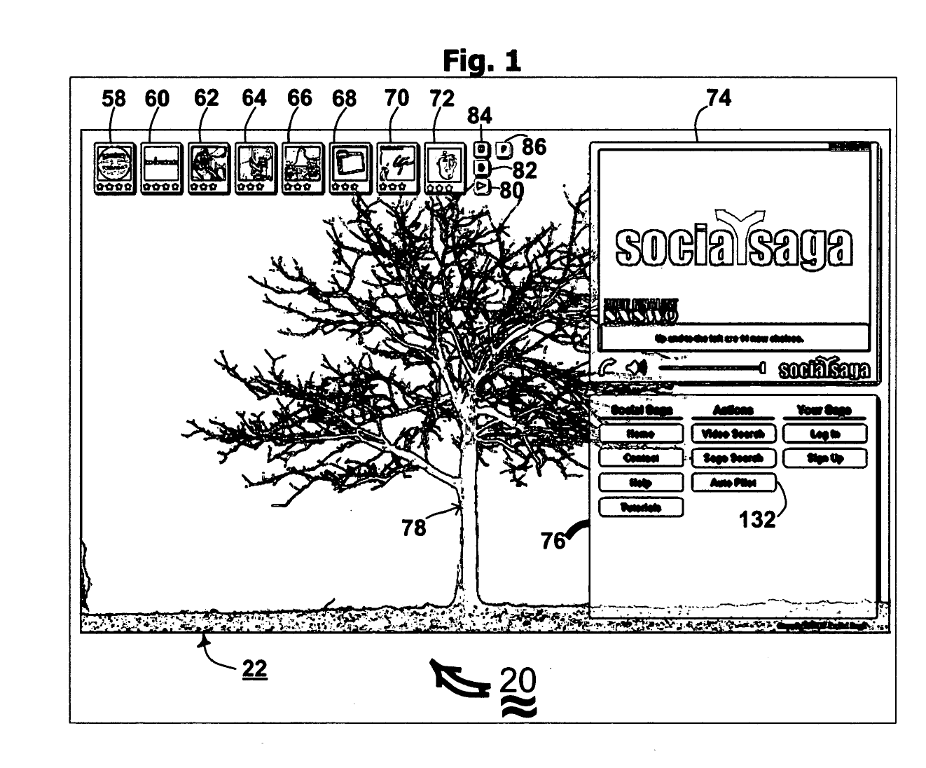

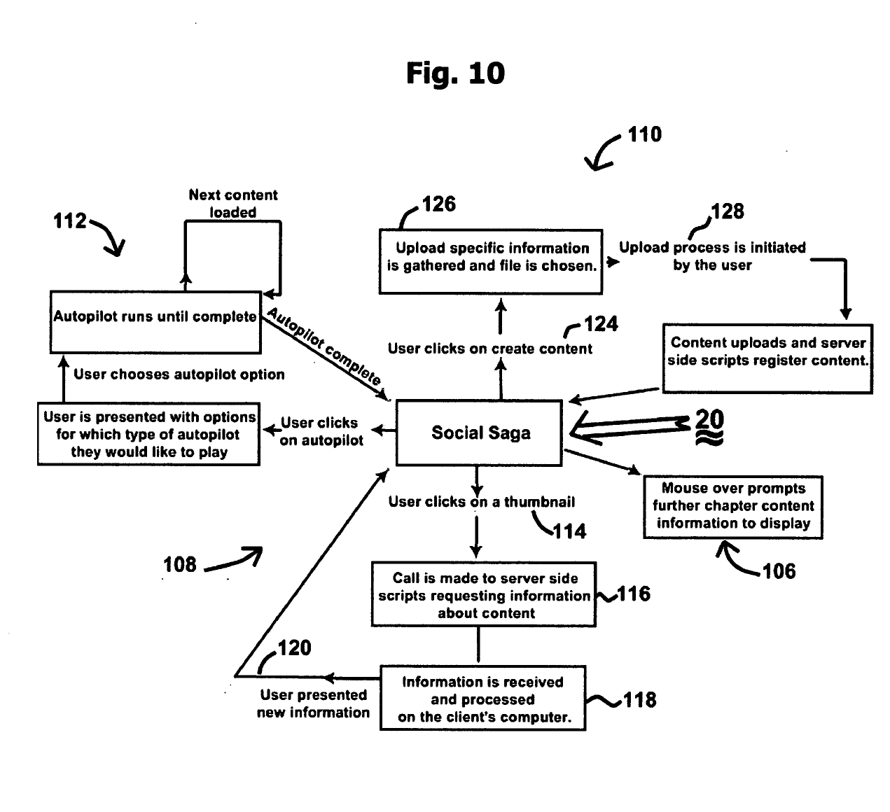

Referring now to the drawings in general and FIG. 1 in particular, an interactive, web-based environment 20 is partially depicted by illustration of homepage 22. Environment 20 allows certain interactive processes to occur as generally illustrated in FIG. 10.

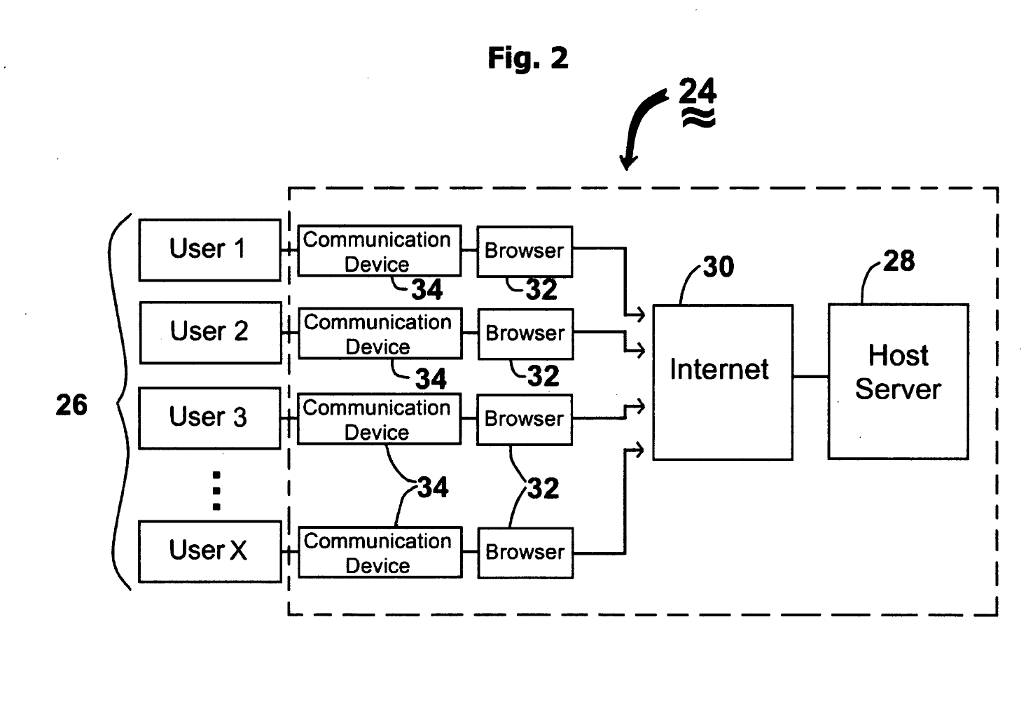

Referring to FIG. 2, a system 24 is shown allowing environment 20 (not shown) to be utilized by one or more human users 26. In particular, system 24 includes a host server 28, internet 30, browser 32, and communications device 34 for each user 26. Host server 28 is a conventional computer functioning as a server. Browser 32 is a web browser such as Internet Explorer or Foxfire (although it is anticipated that a wide variety of web browsers would be supported in the context of the invention). Communication device 34 is any device which can support a web browser 32 and communicate via internet 30. For example, a conventional desktop computer, a laptop computer, Palm Pilot and other similar devices. It is contemplated within the scope of the invention that other communication technologies or platforms other than a web browser might be used in future adaptations or embodiments of the invention.

The recommended system requirements for the communication device 34 of a user 26 are as follows: 1.0 Ghz Processor, Broadband Internet connection, 128 Mb of RAM, and a browser whose creation date is later than 2002. These recommended system requirements are not necessary for utilization of the application, but greatly enhance the user's experience.

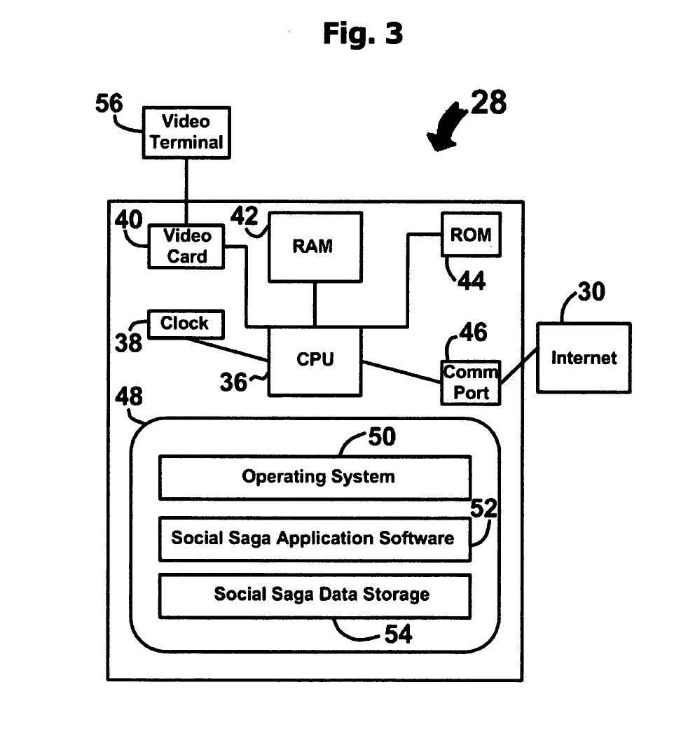

Referring to FIG. 3, the major elements of host server 28 are shown. In particular, host server 28 includes a CPU 36, a clock 38, a video card 40, RAM memory 42, ROM memory 44, a communication port 46, a set of electronically-stored software elements 48, including an operating system 50, a Social Saga application software 52 and a Social Saga data storage 54, as well as a video terminal 56. All elements are conventional in nature although the functionality of Social Saga application software 52 and Social Saga data storage 54 will be discussed below, according to the present invention.

Social Saga application software 52, as discussed above, is loaded on server 28. In preferred embodiments, the software for the user side of the application is written in Actionscript. The presentation layer that the user interacts with is created in the Flash IDE. Server side programming is done in php and perl. Many other programming languages could be used to create an application with similar functionality.

Macromedia Flash Player is downloaded from server 28 to browser 32 (See FIG. 1) to initialize the ability of user 26 to use his communication device 34. After initialization, a Macromedia Flash Movie is implemented on browser 32 during usage of environment 20.

Referring once again to FIG. 1, homepage 22 includes a plurality of root node content chapters 58 through 72, an introduction frame 74, a menu selection frame 76, an aesthetic graphic 78, a Next button 80, a “D” button 82, a “C” 84 and an “F” button 86. Content chapters 58 through 72 are referred to as “root node” content chapters for reasons which will be explained below. Each content chapter (whether of the root node variety or not) contains original information content, typically in video form, however such content may be in a textual form or merely audio or graphical or any other means by which content can be conveyed in electronic or optical medium. When video content is referred to, it is understood that audio content is normally included. Also, it should be noted that a content chapter can include other multi-media combinations of content for example, video with graphical as well as audio or textual information embedded into video content, etc.

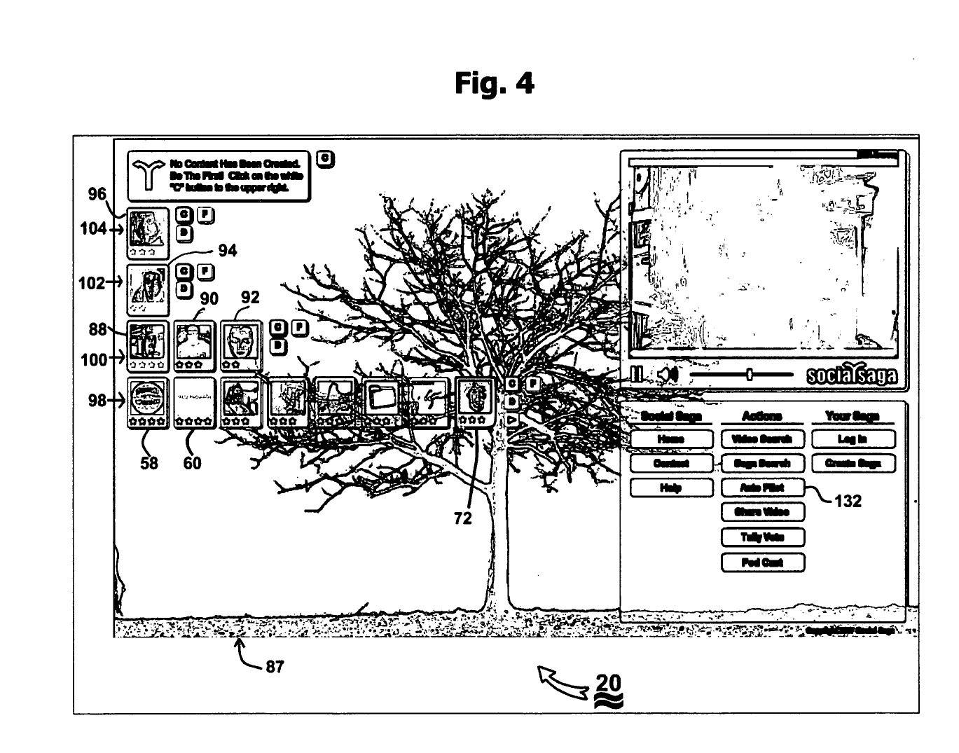

Referring to FIG. 4, depicting a modified display screen 87 in environment 20, content chapters 58 through 72 are displayed as in FIG. 1. In addition, content chapters 88 through 96 are also displayed. Content chapters 58 through 72 form a first content chapter level 98, while content chapters 88 through 92 form a second content chapter level 100. Content chapter 94 forms a third content chapter level 102 and content chapter 96 forms a fourth level 104. How user 26 (not shown in FIG. 4) arrives at display screen 87 will now be discussed.

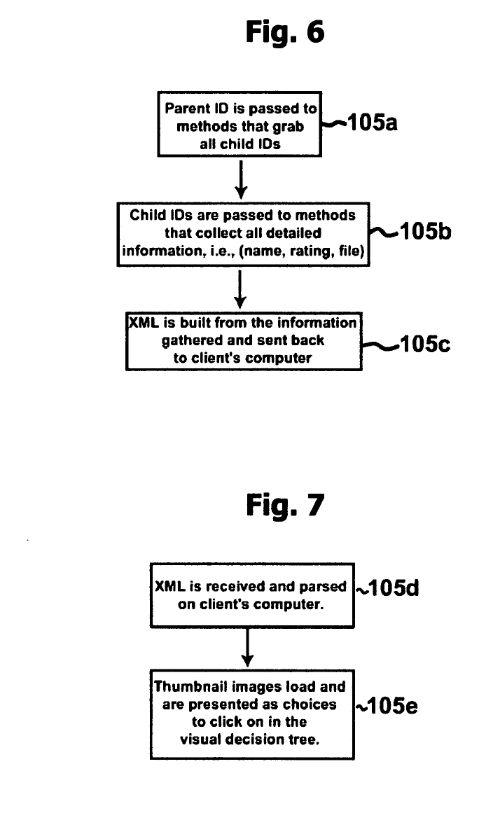

Referring to FIG. 6, a first flowchart box 105a, a second flowchart box 105b, and third flowchart box 105c are depicted. Flow process as described relates to the relationship between particular content chapters. For example, in FIG. 4, node content chapter 72 was selected by user 26 (not shown in FIG. 4) which in turn yielded a display screen also showing content chapters 88, 90 and 92. In this illustration, root node content chapter 72 would be a “parent” and thus the parent identification information of content chapter 72 would be referenced in first flowbox 105a of FIG. 6. The reference in second flowchart box 105b to “child Ids” would refer to the identification information for content chapters 88, 90 and 92. In other words, content chapter 72 is a parent in relation to content chapters 88, 90 and 92. Thus at second flowchart box 105b the identification information for content chapters 88, 90 and 92 is passed to a software method that collects all detailed information associated with content chapters 88, 90 and 92, respectively.

Finally as depicted at third flowchart box 105c, an XML image is built from the information gathered and sent back to communication device 34 of user 26, particularly at web browser 32.

Referring to FIG. 7, flow chart boxes 105d and 105e describe the process by which web browser 32 is updated to reflect the selection of a specific content chapter.

Referring to FIG. 10, the basic functionality of environment 20 for a user 26 (not shown in FIG. 10) is depicted in flowchart format. In particular, the Social Saga environment 20 has an associated content chapter investigation mode 106, a content chapter playback mode 108, a content chapter upload mode 110 and a content chapter autopilot mode 112. In particular with respect to content chapter investigation mode 106, user 26 simply moves his cursor over a particular content chapter and then will be provided with a textual box which provides additional information about that particular content chapter, for example, the genre of content (action, comedy, discussion, etc.), length of the content chapter, etc.

Playback mode 108 will be described by further reference to the figures. Referring first to FIG. 10, user 26 will select a content chapter, as indicated at reference numeral 114 in playback mode 108. With reference to FIG. 1, user 26 will have eight content chapters to choose from. In this example, user 26 decides to pick content chapter 72. He then double clicks on content chapter 72 (as indicated at reference numeral 114 of FIG. 10) and then the process steps indicated by reference numerals 116 and 118 are performed (see also FIGS. 6 and 7 which describe that process in more detail). Still referring to FIG. 10, user's 26 web browser 32 is incorporated to the selection of content chapter 72.

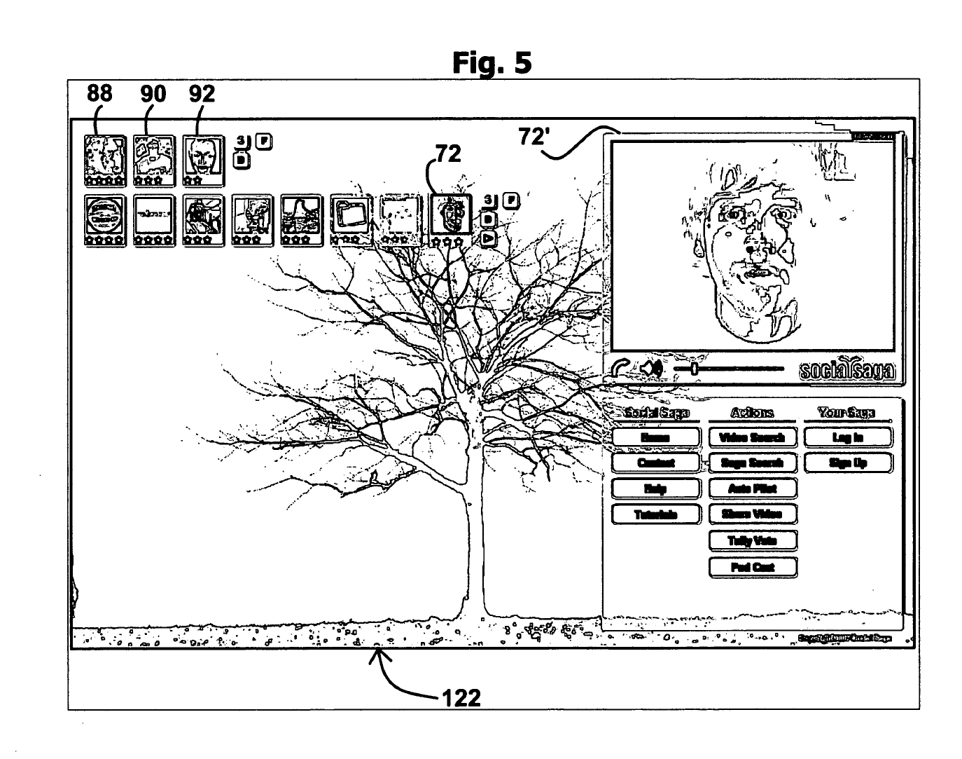

Accordingly, web browser 32 is updated to present display screen 122 as illustrated in FIG. 5. It will be noted that three “child” content chapters 88, 90 and 92, all sequentially related to content chapter 72 are then displayed as well as a streaming video frame 72′ which plays the video content of content chapter 72 for user 26. At this time, user 26 may select any of content chapters 88, 90, or 92 as desired. With reference to FIG. 10 he may utilize content chapter investigation mode 106 as indicated at FIG. 10 to get information on each individual content chapter.

In this example, he then selects content chapter 88, repeating the process described in playback mode 108 at FIG. 10. By selecting content chapter 88 the newly modified display screen will show the third content chapter level 102, which currently only includes one content chapter 94. Finally, he repeats the playback mode process 108 by selecting content chapter 94 which in turn yields display screen 87 having four content chapter levels displayed.

In addition to using playback mode 108 for viewing sequences of existing content, user 26 may also choose, in the preferred embodiment, to upload content of his own. This process is illustrated at FIG. 10 as the content chapter upload mode 110.

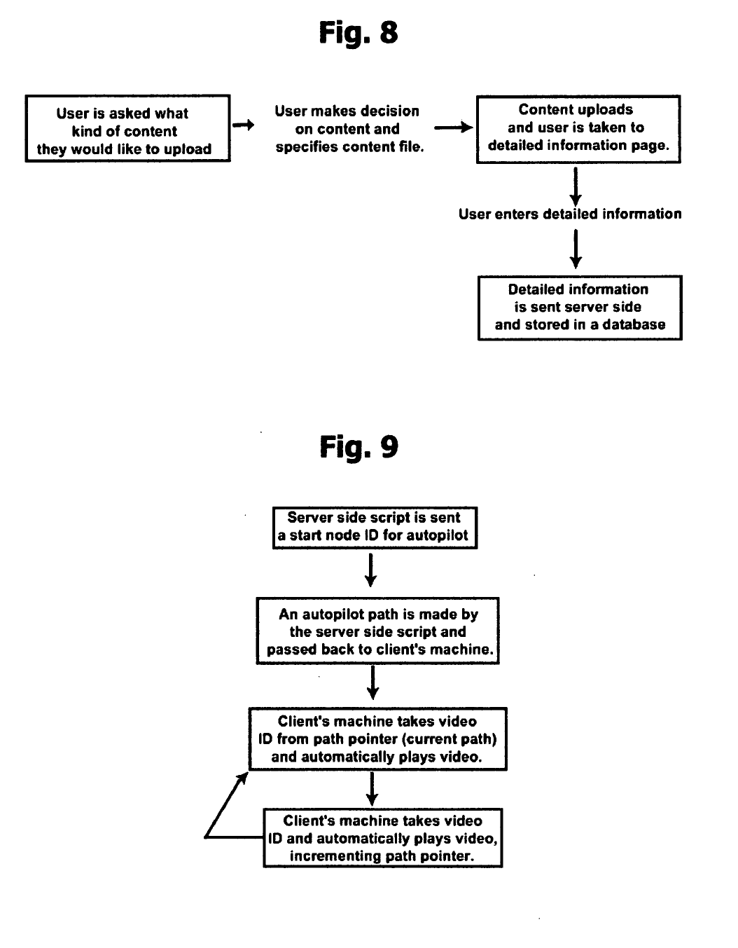

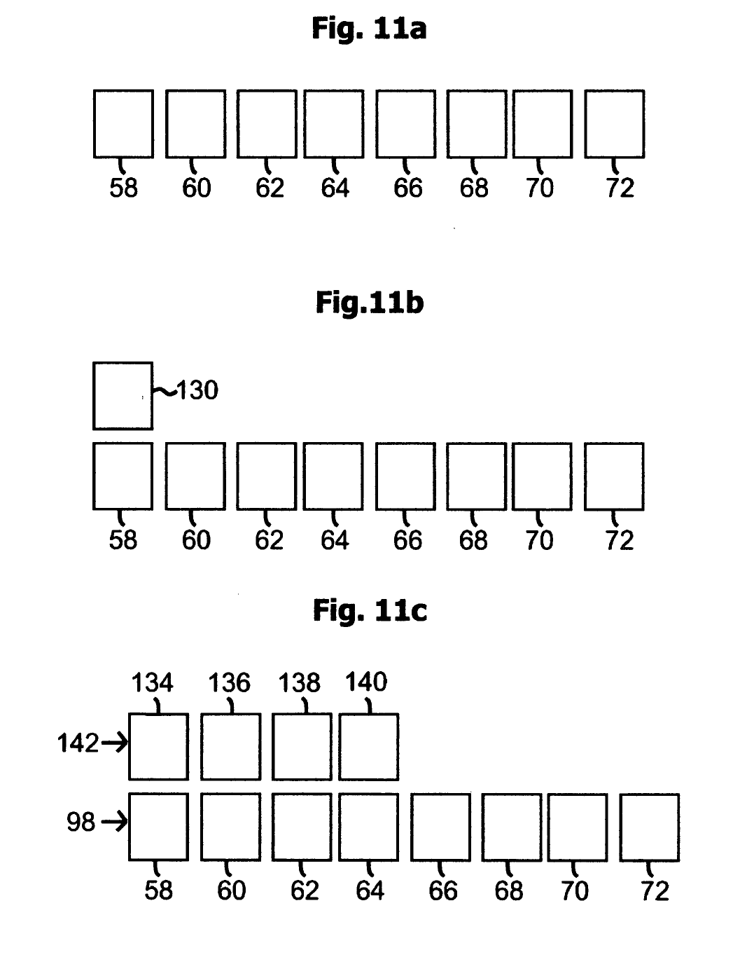

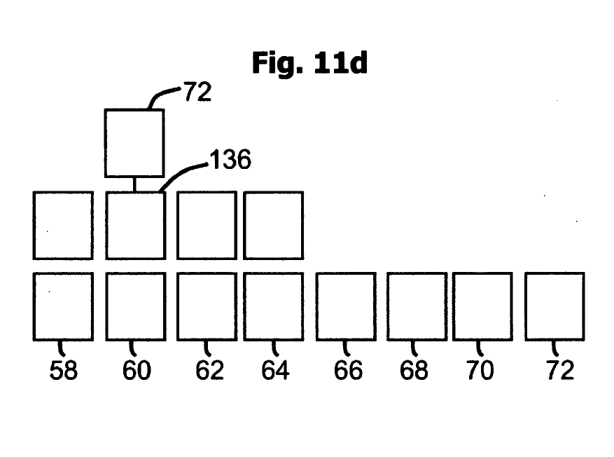

For ease of illustration, reference is made to FIG. 11 a which is an abstract representation of the eight root node content chapters depicted in FIG. 1. As an example, user 26 may select content chapter 58 and decide to upload (i.e. add) a content chapter in sequence to content chapter 58. He will do this by selecting “C” button 84 (shown in FIG. 1) and then the content chapter upload mode 110 will be initiated as indicated at reference numeral 124. User 26 will then be presented with a display screen allowing him to upload a file of content which may be video content, text, etc. User 26 then uploads the content after denominating several categories such as action, comedy, discussion, etc. as indicated in the box at reference numeral 126. The upload process is initiated by user 26 as indicated by reference numeral 128 in FIG. 10. Finally, the content is uploaded on server 28 with side scripts registering the new content chapter. This process is also illustrated at FIG. 8.

In this fashion, user 26 will select, for example content chapter 58 of FIG. 11a and then upload a sequential content chapter as discussed above so that his web browser is updated as shown in FIG. 11b to include his uploaded content chapter 130. In this fashion, all users 26 in the environment 20 will see the new content chapter 130 in respective web browsers 32, whenever any particular user should select content chapter 58 for playback mode.

Referring again to FIG. 10, autopilot mode 112 will now be discussed. Autopilot mode 112, according to the invention, allows user 26 to select a sequence of related content chapters. This process is also illustrated by the flowchart in FIG. 9. In particular, autopilot provides several options. It will be noted by reference to FIG. 1 that menu selection box 76 includes an autopilot button 132. User 26 may then select autopilot based on his own previous sequential selection of content chapters (to be discussed in more detail below). Alternatively he may select another autopilot function based on recent branches (or threads) of content chapters, or a content chapter branch selected by server 28 on the basis of user community popularity or at random or on the basis of newness of the branch, or some combination of such parameters.

Operation of the Social Saga environment 20 will now be discussed in more detail from the perspective of a particular user 26. User 26 will utilize his communication device 34 and web browser 32 to go to the Social Saga environment 20, located at SocialSaga.com on the internet. He will then download a Flash platform from the host server onto his browser 32 in the preferred embodiment. User 26 will then restart his browser with the Flash platform incorporated into his browser 32. It will be readily appreciated that upon subsequent visits to Social Saga environment 20 the Flash platform will always be ready for use. User 26 will typically go homepage display screen 22 as depicted at FIG. 1. He may then assess content chapters 58 through 72 by using the content chapter investigation mode 106 as indicated at FIG. 10. If he chooses not to select any of the content chapters 58 through 72 and desires to view other root node content chapters, he may select the “next” button 80 at which time a new set of root node content chapters will be displayed. Users 26 will ultimately select a particular root node content chapter at which time Social Saga environment 20 will be updated and user 26 will then see the playback of the particular content chapter selected as indicated at the streaming video frame 72′ for content chapter 72, for example, as shown at FIG. 5. User 26 may then choose to respond with uploading content to create a new content chapter, as described at uploading mode 110 in FIG. 10 thereby creating a new content chapter as illustrated at FIG. 11b.

User 26 may also advance up the branch by selecting successive content chapters in each branch.

Branches and trees of content will now be discussed. A content branch is described as at least two sequential content chapters. A tree is made up of one or more branches originating from one root node content chapter.

Additionally, with reference to FIG. 1, user 26 has the option of creating his own root node content chapter.

As another alternative, user 26 may sequentially link unrelated content chapters so that they become sequential. For example, with reference to FIG. 11c, root node content chapters 58 through 72 are shown. Content chapter 58 in this example includes four sequential “child” content chapters 134, 136, 138 and 140 all forming a second content chapter level 142. In this example, root node chapters 60 through 72 have no sequential relationship to content chapters 134 through 140. In utilizing the linking function, user 26 may select one of these unrelated root node content chapters (for example content chapter 72 and decide to link it sequentially to content chapter 136, for example because he believes there is some aesthetic or editorial value in creating this sequence. After completing the linking process, the result will be as displayed at FIG. 11d. In other words, now user 26 has the option to playback root node 58 followed by content chapter 136 and then content chapter 72.

In this example, several branches have been created from the tree originating at root node content chapter 58. In particular, one branch is content chapter 54 and content chapter 134, another branch is content chapter 58 and content chapter 136, another branch is content chapter 58 and content chapter 138, and another branch is content chapter 58 and content chapter 140. And another branch is content chapter 58, content chapter 136 and content chapter 72.

As previously discussed, the autopilot function may be utilized to replay a just completed playback of a sequence of content chapters in a branch. For example, with reference to FIG. 4, if user 26 selected content chapter 72 and then content chapter 88 followed by content chapter 94 and finally content chapter 96, he could then replay that sequence of the four named content chapters automatically by selection of autopilot 132.

Based on the functionality of environment 20, user 26 may thus participate in a community of other users 26 for such purposes as collaborative creation of fictional content, a documentary, or simply a discussion thread (i.e. branch). User 26 may start his own branch by uploading a content chapter to start a new tree or he may participate in a tree already started. In this fashion, a community of users 26 may create fictional stories collaboratively or discuss or inform on desired topics. Users may also take content from an unrelated tree and put it into the sequence of another tree if desired.

In addition, Social Saga may be used for training scenarios. For example, a law enforcement agency as a user could create a tree with several branch scenarios. In that instance it would be possible for the trainee/users interaction to be limited to only to the selection of alternative branches for appropriate training responses. In other words, the trainee/user in such a law enforcement scenario may not be allowed the option to upload content but simply allowed to select alternate branches based on a decision prompt.

It should be apparent that the invention not only accomplishes the major functions required from such systems but does so in a particularly advantageous manner. It should be equally apparent, however, that various minor and equivalent modifications from the embodiments disclosed herein for illustrative purposes could be employed without departing from the essence of the invention. It is to be understood, therefore, that the invention should be regarded as encompassing not only the subject matter literally defined by the claims which follow, but also technical equivalents thereof

What is claimed is:

1. A method of operating a computer system having a web server to provide a web-based, interactive decision tree, including communication content, for distribution to one or more users, the method comprising:
(a) transmitting a user interface providing an interactive decision tree to a web browser operated by a user, wherein the interactive decision tree includes predetermined user interactive choices therewith;
(b) receiving a message from the user indicative of the user's selection of one or more predetermined interactive choices;
(c) modifying the user interface to incorporate the one or more user selected predetermined choices within the computer system; and
(d) transmitting the modified user interface incorporating the predetermined one or more choices to the web browser operated by the user so that the user receives an appropriate response to the one or more choices.

2. The method of claim 1 wherein the one or more interactive choices of step (a) includes uploading content to the web server.

3. The method of claim 2 wherein the uploaded content is video content.

4. The method of claim 2 wherein the uploaded content is audio content.

5. The method of claim 2 wherein the uploaded content is text content.

6. The method of claim 2 wherein the uploaded content is graphical content.

7. The method of claim 2 wherein the uploaded content is multimedia content.

8. downloaded to web browser The method of claim 1, wherein a Shock-Wave-Flash software platform is transmitted to the user to facilitate steps (a) through (d).

9. The method of claim 1, wherein the user has the option to upload a content chapter in order to begin a new interactive decision tree.

10. The method of claim 1, wherein the interactive decision tree includes at least one branch having a plurality of sequential content chapters, each content chapter available for selection by the user for playing, and step (b) includes receiving a message from the user, indicative of the user's selection of one branch containing at least two sequential content chapters for play, such that the user receives a playback of the selected branch.

11. The method of claim 1, wherein the interactive decision tree contains pre-determined created content serving as a training module for the user.

12. The method of claim 1, wherein the interactive decision tree includes one or more content chapters serving as a discussion thread created by a community of users of the system.

13. The method of claim 1, wherein the interactive decision tree includes one or more content chapters serving as a fictional story created by a community of users of the system.

14. The method of claim 1, wherein the interactive decision tree is
substantially all uploaded content added by a community of users.

15. The method of claim 1, wherein one of the interactive user choices includes indicating a preference for one content chapter or a sequence of content chapters.

16. A method of operating a computer system having a web server to provide a web-based, interactive decision tree, including communication content, for distribution to one or more users, the method comprising:
(a) transmitting a user interface providing an interactive decision tree to a web browser operated by a user, wherein the interactive decision tree includes predetermined user interactive choices therewith, at least one of the interactive choices including the option for the user to transmit to the web server video content to be added to the interactive decision tree;
(b) receiving a message from the user indicative of the user's selection of one or more predetermined interactive choices;
(c) modifying the user interface to incorporate the one or more user selected predetermined choices within the computer system; and
(d) transmitting the modified user interface incorporating the predetermined one or more choices to the web browser operated by the user so that the user receives an appropriate response to the one or more choices and also transmitting to any subsequent user the modified user interface incorporating any video content added by the original user.

17. The method of claim 16, wherein the interactive decision tree includes at least one branch having a plurality of sequential content chapters, each content chapter available for selection by the user for playing, and step (b) includes receiving a message from the user, indicative of the user's selection of one branch containing at least two sequential content chapters for play, such that the user receives a playback of the selected branch.

18. A method of operating a computer system having a web server to provide a web-based, interactive decision tree, including communication content, for distribution to one or more users, the method comprising:
(a) transmitting a user interface providing an interactive decision tree to a web browser operated by a user, wherein the interactive decision tree includes at least one branch having a plurality of sequential content chapters, each content chapter available for selection by the user for playing;
(b) receiving a message from the user indicative of the user's selection of one branch containing at least two sequential content chapters for play;
(c) modifying the user interface to incorporate the selected branch within the computer system; and
(d) transmitting the modified user interface incorporating the selected branch to the web browser operated by the user so that the user receives a playback of the selected branch.

19. The method of claim 18, wherein step (b) includes the user's indication whether the at least two sequential content chapters are to be segmented for user comment or substantially seamless during playback.

20. The method of claim 18, wherein step (b) includes the user's indication that the at least two sequential content chapters are automatically determined by his most recent selection of individual content chapters within the decision tree.

21. The method of claim 18, wherein step (b) includes the user's indication that the at least two sequential content chapters are automatically determined by the popularity of individual content chapters within the decision tree, based on pre-selection by a community of users.

22. The method of claim 18, wherein step (b) includes the user's indication that the at least two sequential content chapters are automatically determined by random selection of individual content chapters by the web server.
